(19) United States
(12) Patent Application Publication
(10) Pub. No.: US 2002/0176661 A1
(43) Pub. Date: Nov. 28, 2002

(54) Hybrid one-dimensional mode-matching method between round and elliptical waveguide modes

(76) Inventor: Timothy Edwin Van Eck, Los Altos, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/120,135

(22) Filed: Apr. 11, 2002

Related U.S. Application Data
(60) Provisional application No. 60/282,872, filed on Apr. 11, 2001.

(51) Int. Cl. G02B 6/26; G02B 6/34

(52) U.S. Cl. 385/28; 385/31; 385/36

(57) ABSTRACT

A method and optical mode transform device is given whereby an optical waveguide positioned on a support substrate for receiving light from a optical fiber passing through a mode-matcher converting light from one mode to another to minimize optical loss.

This application is based on Provisional Application 60/282,872 filed Apr. 11, 2001.

### FIELD OF THE INVENTION

The present invention relates to optical waveguides and transmission in devices such as, for example, lasers and polymer modulators. More particularly this invention pertains improvements in efficiency and avoiding mode mismatch. Specifically, this invention relates to devices and methods of resolving one-dimensional mode-mismatch between round and elliptical waveguide modes.

### BACKGROUND OF THE INVENTION

There are several method used to optimize performance of optical waveguides such as, for example, lasers and polymer waveguides. Frequently, the optical mode of light in a waveguide is elliptical in shape while standard optical fibers have round optical modes. The difference in size and dimension between such optical waveguides and optical fibers cause mode mismatch and, thus, inefficiencies in such electro-optic devices.

Some types of optical waveguides such as lasers and polymer modulator waveguides obtain optimal performance when the optical mode of the light in the waveguide is elliptical in shape but, as noted earlier, standard optical fibers have round optical modes. The difference in size and dimension between such optical waveguides and optical fibers causes mode match loss equal to 10×log₁₀ (T), in dB units, where:

$$T = \frac{4}{( \frac{{d}_{f}}{{d}_{a}} + \frac{{d}_{a}}{{d}_{f}} ) ( \frac{{d}_{f}}{{d}_{b}} + \frac{{d}_{b}}{{d}_{f}} )}$$

where d_{f} is the diameter of the fiber mode, dₐ is the major axis diameter of the elliptical waveguide mode, and d_{b} is the minor axis diameter of the elliptical waveguide mode. For example, for a fiber with d_{f}=9 microns, and an optical waveguide with dₐ=10 microns and d_{b}=2 microns, the optical loss from mode mismatch would be 3.8 dB, but if the minor axis diameter could be increased to d_{b}=8 microns, the optical loss from mode mismatch would be reduced to 0.1 dB.

The problem of mode-mismatch has been recognized but not fully resolved. One known method is to reduce the size of the optical beam from a standard optical fiber (e.g., 9 microns) by grinding a cylindrical lens onto the fiber tip, which focuses the light from the fiber in one dimension only, matching it more closely with the smaller of the two optical beam dimensions of the polymer waveguide, provided the polymer waveguide is placed at the focal length of the cylindrical lens.

Another known method is to monolithically integrate a structure, called a spot size transformer, on the same substrate as the polymer waveguide, that adiabatically transforms the elliptical waveguide mode to a large round mode matching the optical mode of a standard optical fiber. This method allows alignment of a large optical mode at the end of the waveguide substrate to another large optical mode at the tip of a standard fiber.

For the cylindrical lens on the fiber, the principle performance problem is that the mode matching is achieved by making a large spot small, rather than by making a small spot large, so the alignment tolerance between the lensed fiber and the waveguide is very tight. The cylindrical lensed fiber also has the problem of the high cost of individually grinding each fiber to a cylindrical shape with tight tolerance.

For the spot size transformer solution, one problem is that the spot sized transformer is a very complex structure, requiring patterning of both the in-plane shape and thickness of structures, and it requires novel fabrication processes, so it may be expensive and low-yield. Also, the materials making up the polymer waveguides are optimized for performance of the modulator, not the performance of fabrication of the spot size transformer, further increasing the complexity and cost of the method.

### SUMMARY OF THE INVENTION

The techniques and methods of this invention have been found to be useful whereby a one-dimensional mode-matching system can solve problems of mode-mismatch in waveguide-fiber and optic cable arrangements. By this invention optimal performance between waveguides and optical fibers is established.

It is an object of this invention to resolve dimensional mode-mismatch in waveguide and optical fiber systems.

It is a further object of this invention to establish a one-dimensional mode-matching system.

It is a yet a further object of this invention to transform small spot dimensions to a large spot dimensions on the same substrate as the optical waveguide.

By this invention a structure is provided to transform a small spot dimension to a large spot dimension on the same substrate as the optical waveguide. More importantly, in one preferred implementation of this invention, the transformance between the small spot dimension to the large spot dimension is self-aligned to the waveguide center, so alignment between fiber and the waveguide can be achieved, with loose tolerance

The structure that transforms a small spot dimension to a large spot dimension is on the same substrate as the optical waveguide, and in some implementations self-aligned to the waveguide center, so alignment between fiber and waveguide can be done between two large spots, with loose tolerance.

The structure of this invention that transform a small spot dimension to a large spot dimension is further capable of self-alignment allowing an automatic alignment of the mode matching structure to the optical waveguide.

Also, the structures described in this invention are simpler, thus less costly, than the prior art.

### DESCRIPTION OF THE DRAWINGS

FIG. 1 is a side view of the general mode-matching concept of this invention.

FIG. 2 is a side view of a hybrid one-dimensional mode-matching showing the substrate, waveguide and mode-matcher but without a pedestal

FIG. 3 is a side view of a prism system hybrid mode-matcher.

FIG. 4 is a side view of a cylinder lens hybrid mode-matcher.

FIG. 5 is a side view of an axially gradient index lens hybrid mode matcher.

### DETAILED DESCRIPTION OF THE INVENTION

The benefits and advantages of this invention waveguides are obtained by apparatus and method of reducing the optical light difference in size and dimension between an optical waveguides and optical fibers.

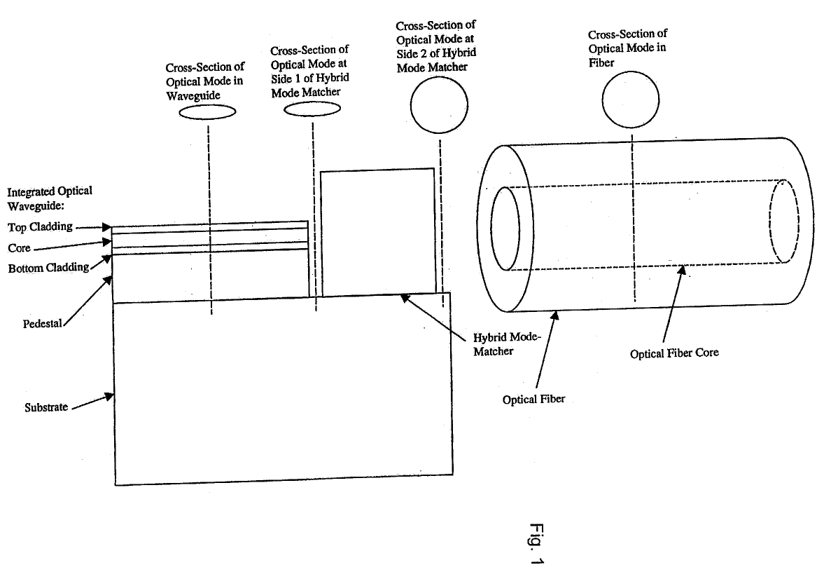

Many types of optical waveguides demonstrate optimum performance when the optical mode of the fiber optic path and the waveguide have approximately the same dimensions and shape. But since modulator waveguides and other types of structures generally have optimal performance when the optical mode of the light in the waveguide is elliptical in shape which is seen in FIG. 1, the standard round optical fibers have a different modes. By reducing the difference in size and dimension between such optical waveguides and optical fibers significant improvement can be achieved.

This invention is a method for making a mode-matcher that will transform light from the elliptical mode to the round mode. By the method of this invention the mode-matcher will transfer light from the round mode to the elliptical mode because the devices of this invention are or can be bi-directional. The mode matcher of this invention can be advantageously on the same substrate as the optical waveguide, and create a large round mode registered to the waveguide substrate, which can then be aligned to the large round mode of an optical fiber, with loose alignment tolerance.

In FIG. 1 there is shown an optical waveguide that has been fabricated on a substrate, with a core layer that confines light and cladding layers above and below it. A lateral confinement is also present (not shown). A cross section of the elliptical optical mode of the optical waveguide is also shown.

A standard optical fiber is shown in FIG. 1 to the right of the optical waveguide with a light-confining core in the center surrounded by a cladding. The large round optical mode is also shown in cross-section.

This invention addresses the problem in which one axis diameter of the optical waveguide mode, such as the major axis diameter, is similar in size to the optical fiber mode diameter, and the other axis diameter, such as the minor axis diameter, is significantly dissimilar in size. Frequently the optical waveguide is much smaller when compared to the to the optical fiber mode diameter, as illustrated in FIG. 1.

FIG. 1 also shows the mode matcher, which can have one of several different implementations, which is itself fabricated on the same substrate as the waveguide, using compatible materials and fabrication processes, so it is self-aligned to the waveguide. When the elliptical waveguide mode enters the mode matcher from the proper side (from the left side in FIG. 1), it is transformed into a large round mode very similar in size to the optical fiber mode, which exits on the opposite side. In this configuration, the mode mismatch with the optical fiber mode will be small.

The hybrid mode matcher can be bi-directional, so that when an optical fiber mode entering from the proper side (from the right side in FIG. 1), it is transformed into an elliptical mode very similar in dimensions to the optic waveguide. In this operation the mode mismatch with the hybrid optical waveguide mode will be small.

Since the optical fiber mode is larger in one dimension than the optic waveguide mode, it may be partially blocked by the substrate. This is conveniently resolved by elevating the optical waveguide from the substrate by fabricating it on a pedestal, which is not usually a part of the optical structure of the optical waveguide nor part of any related electrical circuit. The pedestal may be simply a uniform film of some neutral and compatible material that covers the substrate everywhere except where the mode matcher is fabricated. In some implementations of this invention the pedestal forms part of the mode matcher, as does a similar layer on top of the waveguide which can be called the top pedestal.

This invention includes any type of mode matcher performing the function described above, namely that it will alter, for example expand, the size of the mode in one dimension, but may leave the mode size substantially unchanged in the other dimension.

FIG. 1 additionally shows the hybrid mode-matcher, which can have one of several different implementations, which is itself made separately and then mounted on the same substrate that the optical waveguide is fabricated on, or in some other way registered to the substrate. When the elliptical waveguide mode enters the hybrid mode matcher from the proper side (from the left side in FIG. 1), it is transformed into a large round mode very similar in size to the optical fiber mode, which exits on the opposite side, so that the mode mismatch with the optical fiber mode will be small. The hybrid mode matcher can be bi-directional, so that when an optical fiber mode entering from the proper side (from the right side in FIG. 1), it is transformed into an elliptical mode very similar in dimensions to the optic waveguide, exiting on the opposite side, so that the mode mismatch with the optical waveguide mode will be small.

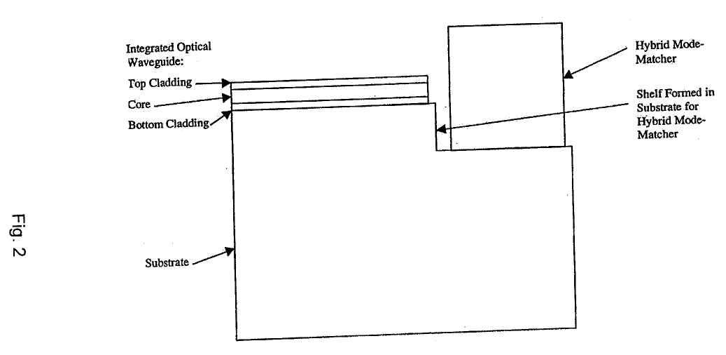

Since the optical fiber mode is larger in one dimension than the optic waveguide mode, it may be partially blocked by the substrate if the optical waveguide is not elevated from the substrate by fabricating it on a pedestal, which is not part of the optical structure of the optical waveguide, nor part of any related electrical circuit. The pedestal may be simply a uniform film of some neutral and compatible material that covers the substrate everywhere except where the hybrid mode matcher is mounted. Except for elevating the optical waveguide above the substrate, the pedestal is otherwise not a critical part of the method described here. In fact, FIG. 2 illustrates an alternative method for achieving the required vertical offset between the waveguide and mode matcher, by lowering the hybrid mode matcher rather than elevating the waveguide. The waveguide top cladding, core, and bottom cladding, and the hybrid mode matcher, are as described in FIG. 1. In the region where the hybrid mode matcher is to be mounted, part of the substrate has been removed to form a shelf to support the hybrid mode matcher at the required elevation. The shelf may be formed by a variety of methods, including masking and wet etching or dry etching the substrate, masking and ion milling the substrate, or cutting the substrate to the desired depth with a precision wafer dicing saw.

This invention includes any type of hybrid mode matcher performing the function described above, namely that it will alter, for example expand, the size of the mode in one dimension, but may leave the mode size substantially unchanged in the other dimension.

Some specific examples and embodiments of this invention will be illustrated and explained.

One implementation of the hybrid mode matcher is a prism or system of prisms that change the elliptical mode size in one dimension but not in the other dimension. Such a system of prisms makes use of the refraction of light at an interface between two materials with different refractive indices to expand a beam by bending it in one direction, but not in the orthogonal direction.

A prism has the same triangular cross-section along its entire length. The refraction of light at such an interface is governed by Snell's Law, n₁, sin(θ₁,)=n₂ sin(θ₂), where n₁, is the refractive index in the first material, θ₁, is the angle between the incident beam in the first material and the line perpendicular to the interface between the two materials, n₂ is the refractive index in-the second material, and θ₂ is the angle between the transmitted beam in the second material/and the line perpendicular to the interface between the two materials. A collimated beam propagating from a lower-index material to a higher-index material will be bent closer to the perpendicular line. The transmitted beam will have a larger cross-section, in the direction of the bend, than the incident beam, but in the direction orthogonal to the bend, the beam is not bent, so the cross-section is not changed. A beam propagating from a higher-index material to a lower-index material will be bent farther away from the perpendicular, so the cross-section will be reduced in the direction of the bend.

The exception to these rules is the case when the incident beam is perpendicular to the interface, because then θ₁, and θ₂ are both zero, so there is no beam bending. If the prism system is arranged so that light passes from the lower-index prism to the higher-index prism at a non-zero- angle, causing one-dimension beam expansion, then passes from the higher-index prism to the lower-index prism perpendicular to the interface, so that there is no beam contraction, then an overall expansion of the beam in one dimension will result.

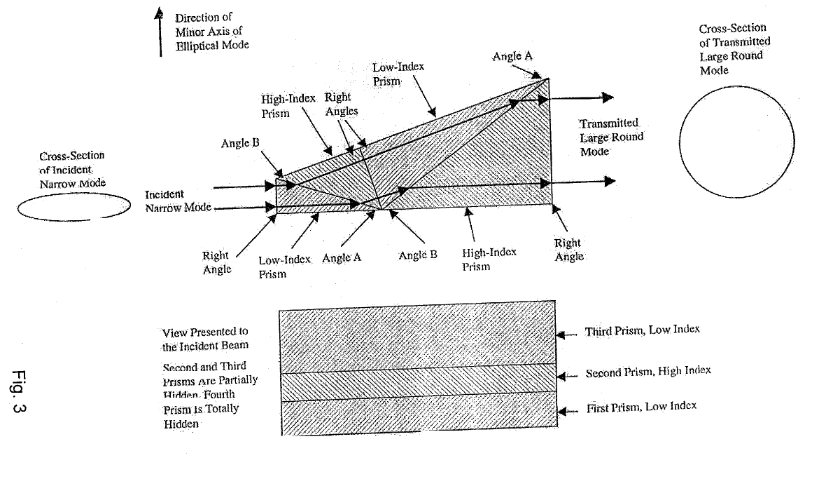

One implementation of a system of prisms that would achieve such an expansion of the minor axis is illustrated in FIG. 3. This particular implementation addresses the combination of mode sizes cited above, where an expansion of the minor axis d_{b} by approximately a factor of four is desired, to achieve much less mode mismatch loss. The side view shows four prisms bonded to each other. The first prism from the left has a lower refractive index, n₁, and its cross-section is a triangle with one right angle, and the smaller of the other two angles is A. Light incident from the left, perpendicular to the shortest prism face, will not be bent by the first prism. The second prism has a higher refractive index, n₂, and its cross-section is a triangle with one right angle, and the smaller of the other two angles is B. The light passing from the first prism to the second is bent according to Snell's Law, causing the minor axis of the beam to expand. The third prism has the same refractive index and angles as the first, but is larger. The light passes from the second to the third prism perpendicular to the interface, so it is not bent, thus not demagnified. The fourth prism has the same refractive index and angles as the second, but is larger. The light passing from the third prism to the fourth is bent, causing still more expansion of the minor axis. Finally, the beam exits the fourth prism perpendicular to the interface, so it is neither bent nor demagnified. Since the beam is translated upward in addition to expanding, there is no need to either fabricate the waveguide on a pedestal or etch a shelf into the substrate for the hybrid mode matcher to sit on. For the system of prisms shown in FIG. 3, if n₁,=1.5, n₂=1.8, A=19.5 degrees, and B=37.5 degrees, then the total expansion of the beam is approximately a factor of 4 in the direction of the beam bending. The end view, specifically the view presented to the incident beam, has no horizontal variation, that being the nature of a prism, so the prisms need only be wider than the major axis diameter of the incident beam to accommodate the beam without causing any significant change in the major axis diameter. The prisms may have anti-reflection coatings on the interfaces to minimize loss of optical power by Fresnel reflection. The alignment tolerance of the system of prisms to the optical waveguide can be very loose, since a vertical offset does not affect the operation, as long as the optical beam is not clipped by the edge of any prism.

The systems of prisms, if all attached to one another, may be fabricated many times wider than the wider dimension of the elliptical beam, then separated into many pieces of the required width using a precision wafer dicing saw; this fabrication method-will significantly reduce the cost per piece.

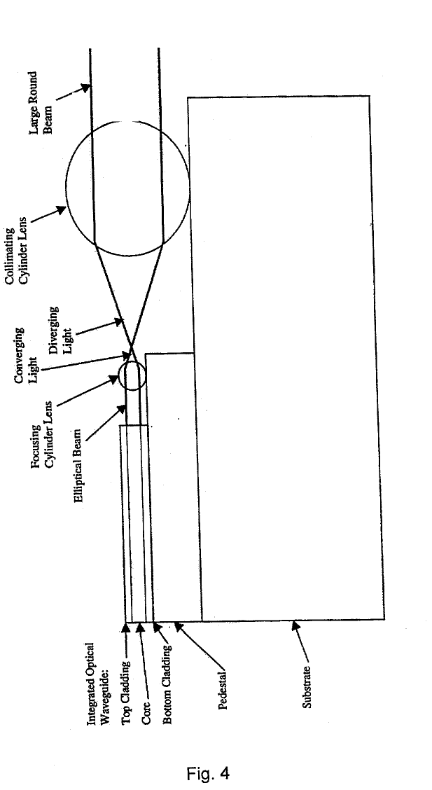

Another class of implementations of the hybrid mode matcher uses small optical elements with focusing power in only dimension, such as the dimension of the minor axis of the elliptical waveguide mode, both mounted on the substrate, or otherwise registered to it, the first to focus the beam in the dimension requiring enlargement, allowing divergence to the required size, and the second to collimate the light after the required divergence. The elements have no focusing power in the other dimension, so they do not cause focusing, divergence, or collimation, but leave the beam size unchanged in one axis, such as the major axis of the elliptical waveguide mode. One such implementation is illustrated in FIG. 4. This illustration contains the same substrate, pedestal, and optical waveguide as FIG. 1. The beam exiting the waveguide is an elliptical beam with, in this example, the vertical mode size much smaller than the optical fiber mode size, but the horizontal mode size similar to the optical fiber mode size. A transparent cylinder, which could be a drawn glass optical fiber without a core, but only solid cladding, is placed with its axis parallel to the plane of the substrate and perpendicular to the direction of light propagation from the waveguide. The cylinder is mounted so that it intercepts the beam from the optical waveguide, and focuses it vertically, but does not affect it horizontally. It may be mounted on the same pedestal as the waveguide, or on some other mount. The focused light is allowed to continue propagating past the focal point, so that it diverges. In or near the plane where the beam reaches the desired vertical width, a second transparent cylinder is placed, with less focusing power, for example a glass cylinder with a larger diameter than the focusing cylinder, or a smaller refractive index. The second cylinder is placed parallel to the first, and in such a position that it also intercepts the light at a position where it has reached the required vertical width. The focusing power of the second cylinder is chosen so that it collimates the beam, resulting in an optical beam that is well matched to a standard optical fiber mode both in the vertical and horizontal dimensions. The second cylinder may be mounted on the substrate, or on some other support.

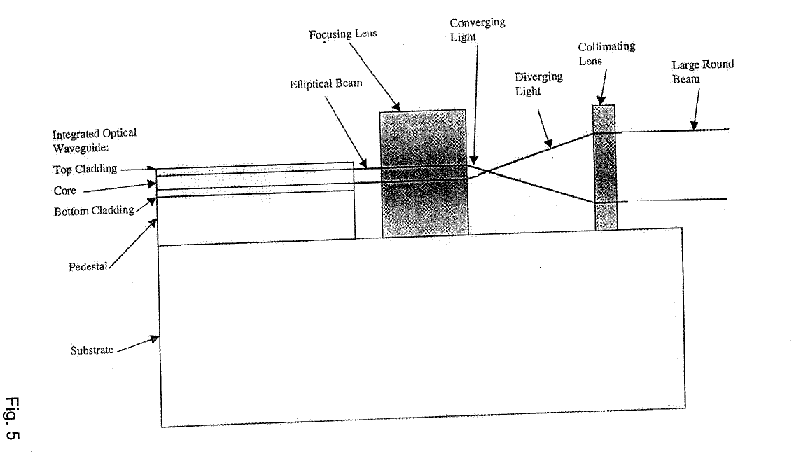

Another implementation of this class is illustrated in FIG. 5. The optical focusing, diverging, and collimating are the same as in FIG. 4, but only the implementations of the lenses are different. Both lenses consist of blocks with axially gradient index (such as the Gradium™ material offered as a custom designed product by LightPath Technologies,. Inc., Albuquerque, N. Mex.) such that the refractive index varies quadratically in the vertical dimension, with maximum refractive index in the center of the block, giving the block focusing power proportional to its thickness along the axis of light propagation. The focusing lens is thick enough to give it enough focusing power to cause divergence to the vertical width required to match the optical fiber mode. The collimating lens is placed where the beam has the required vertical width, and the collimating lens may be significantly thinner than the focusing lens, because less focusing power is needed to collimate the large beam. For both the cylinder lens and gradient lens implementations, it may be possible to omit the focusing lens, if the minor axis diameter is small enough to cause adequate divergence because of light diffraction.

By this invention a reduction high optical loss occurring between a polymer waveguide mode, which is elliptical (e.g., 2 microns×10 microns), and a fiber mode, which is round (e.g., 9 microns×9 microns), can be specifically achieved. And the cost can be reduce the cost in doing so.

For some applications in radio frequency or RF distribution and frequency shifting, the gain an dynamic range of applications in RF distribution and frequency shifting, the gain and dynamic range of the RF link or frequency shifter increase (improve), and the noise figure decreases (improves), as the optical insertion loss decreases. For other applications, which might tend to be digital rather than RF in nature, the invention minimizes optical loss. This enables drop-in replacement for some incumbent technologies, which have higher electrical voltage and electrical power requirements and higher cost, and also reducing the requirement for optical drive power and overall system power.

By employing an hybrid system, the individual components can be optimized and, thus, improved results and lower costs achieved.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments.

What is claimed is:

1. A hybrid optical mode transform device comprising an optical waveguide positioned on a support substrate for receiving light from a optical fiber passing through a mode-matcher converting the light from a substantially circular cross-section to a substantially elliptical cross-section.

2. The optical mode transform device of claim 1 wherein the mode-matcher comprise at least one prism system.

3. The optical mode transform device of claim 1 wherein fiber optics are positioned on said support substrate to receive transformed light from the mode-matcher.

4. The optical mode transform device of claim 1 wherein the waveguide is elevated above the support substrate to receive transformed light from the mode-matcher.

5. A optical mode transform device comprising an optical waveguide positioned on a support substrate communicating light which passes through a mode-matcher focusing the light to reduce mode mismatch with an optical fiber.

6. The optical mode transform device of claim 5 wherein said waveguide, mode-matcher, and optical fiber are supported on said support substrate.

7. The optical mode transform device of claim 5 wherein said mode-matcher is an optical focusing element having focusing power in at least one dimension.

8. A method for reducing optical loss between a waveguide and an optical fiber comprising passing light through a focusing mode-matcher to minimize optical loss.

9. The method of claim 8 wherein the light passing through said mode-matcher is focused in at least one dimension.
